(19) United States
(12) Patent Application Publication
(10) Pub. No.: US 2021/0324776 A1
(43) Pub. Date: Oct. 21, 2021

(54) FLUID TANK THAWING SYSTEM

(71) Applicant: CNH Industrial America LLC, New Holland, PA (US)

(72) Inventors: Samrendra Singh, Bolingbrook, IL (US); Panos Tamamidis, Mount Prospect, IL (US); Kaushal Ghorpade, Chicago, IL (US); Luca Levato, Modena (IT)

(73) Assignee: CNH Industrial America LLC

(21) Appl. No.: 17/233,936

(22) Filed: Apr. 19, 2021

Related U.S. Application Data
(60) Provisional application No. 63/012,470, filed on Apr. 20, 2020.

(51) Int. Cl. F01N 3/20

(52) U.S. Cl. CPC F01N 3/2066; F01N 2590/08; F01N 2610/02; F01N 2610/10; F01N 2610/1406; F01N 2610/1486; F01N 2900/0408; F01N 2570/14

(57) ABSTRACT

A fluid tank thaw system that includes a fluid tank that receives a first fluid. A heating element within the fluid tank that heats the first fluid. A magnetic stir system that stirs the first fluid within the fluid tank to increase a thaw rate of the first fluid. The magnetic stir system includes a magnetic stirrer within the fluid tank. The magnetic stirrer rotates within the fluid tank to agitate the first fluid. An electric coil changes polarity to rotate the magnetic stirrer.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

The agricultural industry uses a variety of tools and machines to harvest crops. For example, a combine harvester is a machine that uses a thresher to harvest grains, such as wheat and barley. Other equipment used by the agricultural industry may include tractors that pull planters, seed drills, plow, among others. These tractors and harvesters typically generate power using diesel engines. Unfortunately, diesel engines may produce gaseous emissions that include nitrogen oxides. In order to reduce nitrogen oxides in emissions, vehicles may use diesel exhaust fluid (DEF). DEF is an aqueous urea solution. In operation, the diesel exhaust fluid is injected into the exhaust line where it catalytically reduces nitrogen oxides into water and nitrogen lowering nitrogen oxide emissions. Unfortunately, the aqueous solution may freeze on cold days.

### BRIEF DESCRIPTION

This brief description is provided to introduce a selection of concepts that are further described below in the detailed description. This summary is not intended to identify key or essential features of the claimed subject matter, nor is it intended to be used as an aid in limiting the scope of the claimed subject matter.

In one example, a fluid tank thaw system that includes a fluid tank that receives a first fluid. A heating element within the fluid tank that heats the first fluid. A magnetic stir system that stirs the first fluid within the fluid tank to increase a thaw rate of the first fluid. The magnetic stir system includes a magnetic stirrer within the fluid tank. The magnetic stirrer rotates within the fluid tank to agitate the first fluid. An electric coil changes polarity to rotate the magnetic stirrer.

In another example, a fluid tank thaw system that includes a fluid tank that receives a first fluid. A conduit within the fluid tank. The conduit guides a second fluid through the fluid tank to heat the first fluid. A magnetic stir system stirs the first fluid within the fluid tank to increase a thaw rate of the first fluid. The magnetic stir system includes a magnetic stirrer within the fluid tank. The magnetic stirrer rotates within the fluid tank to agitate the first fluid. An electric coil changes polarity to rotate the magnetic stirrer.

### DRAWINGS

These and other features, aspects, and advantages of the present disclosure will become better understood when the following detailed description is read with reference to the accompanying drawings in which like characters represent like parts throughout the drawings, wherein:

FIG. 1 is a cross-sectional view of a fluid tank thaw system, in accordance with an embodiment of the present disclosure;

FIG. 2 is a cross-sectional view of a fluid tank thaw system, in accordance with an embodiment of the present disclosure;

FIG. 3 is a cross-sectional view of a fluid tank thaw system, in accordance with an embodiment of the present disclosure;

FIG. 4 is a perspective view of a magnetic stirrer, in accordance with an embodiment of the present disclosure; and

FIG. 5 is a perspective view of a magnetic stirrer, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection, and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

Harvesters and tractors are typically self-propelled vehicles with an internal combustion engine. These internal combustion engines are typically diesel engines. Diesel engines ignite a fuel air mixture by mechanically compressing the mixture until combustion. In order to reduce soot production and to exhaust the fuel, diesel engines inject excess air into the chamber to ensure complete or near complete combustion of the fuel. This may be referred to as a lean burn. Unfortunately, the excess air enables nitrogen oxides to form in the exhaust gas. In order to reduce the amount of nitrogen oxides released into the environment, a diesel exhaust fluid (DEF) may be injected into the exhaust line to catalytically reduce the nitrogen oxides into other substances. For example, an aqueous urea solution may be injected into the exhaust line. In the exhaust line the aqueous urea vaporizes forming ammonia and carbon dioxide. The nitrogen oxides react with the ammonia to form water and nitrogen, which is then expelled by the vehicle.

Harvesters, tractors, and other vehicles that use diesel engines may therefore include a DEF tank that stores the diesel exhaust fluid for use during operation. Unfortunately, DEF may freeze on cold days, which may limit its use. The disclosure below discloses a heating system that melts frozen DEF. To facilitate the melting of the DEF, a magnetic stir system is included. The magnetic stir system agitates the liquid DEF, which further facilitates melting of the frozen DEF through convection. The magnetic stirrer may also facilitate mixing of the DEF after melting increasing the uniformity of the mixture (e.g., uniform mixing of the urea in the water).

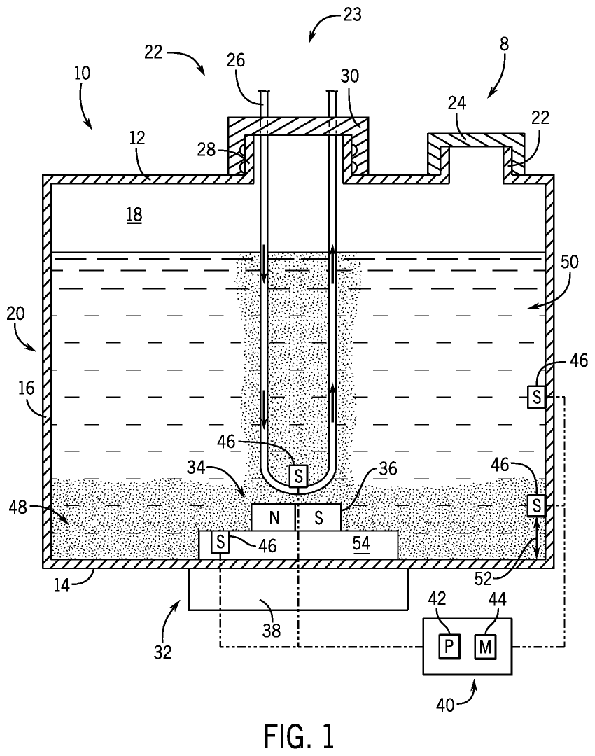

FIG. 1 is a cross-sectional view of a fluid tank thaw system 8 that couples to a DEF tank 10. The DEF tank 10 may be placed on an agricultural vehicle or otherwise used with an internal combustion engine (e.g., diesel engine). The tank 10 includes a top wall 12, a bottom wall 14, and a side wall 16 that extends between the bottom wall 14 and the top wall 12. The side wall 16 may form a variety of shapes including square, rectangular, circular, oval, among others. Together the top wall 12, bottom wall 14, and side wall 16 form a cavity 18 that receives a diesel emission fluid (DEF) 20. The DEF 20 enters the tank 10 through a first inlet 22 that is opened and closed with a cap 24. To fill the DEF tank 10, the cap 24 is removed and DEF 20 is pumped into the tank 10 through the first inlet 22.

As mentioned above, the DEF 20 may be a mixture of urea and water. This mixture may freeze during cold days blocking the release and use of the DEF 20 for use in reducing undesirable emissions. To enable the rapid melting of the DEF 20, the fluid tank thaw system 8 includes a heating system 23. The heating system 23 includes a heating element 26 that extends into the DEF tank 10 to heat and melt the DEF 20. In one example, the heating element 26 may be a conduit that carries a fluid with a temperature that is greater than the freezing point of the DEF 20 (e.g., hot engine coolant). In another example, the heating element 26 may be an electrical wire that generates heat through electrical resistance. As illustrated, the heating element 26 is inserted into the cavity 18 through a second inlet 28 and held in place with a cap 30. The heating element 26 passes through the cap 30 enabling the cap 30 to couple to the heating element 26, which supports and facilitates its removal.

To facilitate melting, the fluid tank thaw system 8 includes a magnetic stir system 32. The magnetic stir system 32 includes a magnetic stirrer 34 that is placed within the tank 10. The magnetic stirrer 34 includes one or more permanent magnets 36. The permanent magnets 36 of the magnetic stirrer 34 are configured to interact with a magnetic field generated by an electric coil(s) 38. In operation, the electric coil 38 generates a magnetic field that attracts and/or repels the permanent magnet 36 of the magnetic stirrer 34. The rapid switching of the magnetic field between attracting and repelling the permanent magnet 36 enables the electric coil 38 to rotate the magnetic stirrer 34. As illustrated, the electric coil 38 is coupled to a bottom wall 14 of the tank 10. In some embodiments, the electric coil 38 may be placed within the tank 10 or within the wall bottom wall 14.

A controller 40 controls the generation of the magnetic field by the electric coil 38. The controller 40 includes a processor 42 and a memory 44. The processor 42 may include multiple microprocessors, one or more “general-purpose” microprocessors, one or more special-purpose microprocessors, and/or one or more application specific integrated circuits (ASICs), field-programmable gate arrays (FPGAs), or some combination thereof. For example, the processor 42 may include one or more reduced instruction set (RISC) processors.

The memory 44 may include a volatile memory, such as random access memory (RAM), and/or a nonvolatile memory, such as read-only memory (ROM). The memory 44 may store a variety of information and may be used for various purposes. For example, the memory 44 may store processor executable instructions, such as firmware or software, for the processor 42 to execute. The memory 44 may include ROM, flash memory, a hard drive, or any other suitable optical, magnetic, or solid-state storage medium, or a combination thereof. The memory 44 may store data, instructions, and any other suitable data.

In operation, the processor 42 executes instructions stored by the memory 44 to control the electric coil 38. For example, the controller 40 may increase and decrease the spin rate of the magnetic stirrer 34 by controlling how often the polarity of the magnetic field changes. In some embodiments, the fluid tank thaw system 8 may include one or more temperature sensors and/or liquid sensors 46. The controller 40 couples (e.g., wired and/or wirelessly) to the sensor 46 and in response to feedback may control operation of the electric coil 38. For example, the sensor 46 may be a temperature sensor that emits a signal indicative of the temperature of the surrounding DEF 20. As the controller 40 receives this signal, the controller 40 determines if the temperature of the surrounding DEF 20 is indicative of liquid DEF 48 (e.g., 32 degrees Fahrenheit or greater) or of frozen DEF 50. If indicative of liquid DEF 48, the controller 40 may determine that the magnetic stirrer 34 is not encased in frozen DEF 50 and is therefore able to facilitate convective heat transfer by agitating the DEF 20. Convective heat transfer via agitation of the DEF 20 may accelerate the melting of frozen DEF 50.

As explained above, the sensor 46 may also be a liquid sensor. In other words, the sensor 46 may emit a signal indicative of liquid when in the presence of a liquid. In response to this signal, the controller 40 may determine that the magnetic stirrer 34 is not encased in frozen DEF 50 and is therefore able to facilitate convective heat transfer by agitating the DEF 20.

In order for the controller 40 to determine that the magnetic stirrer 34 is not encased in frozen DEF 50, the sensors 46 may be placed in a variety of location in the tank 10. For example, the sensors 46 may couple to the side wall 16 at a distance 52 from the bottom wall 14. In this position, the sensors 46 may be approximately level with the magnetic stirrer 34 and therefore the detection of liquid surrounding the sensors 46 is indicative that the magnetic stirrer 34 is not encased in frozen DEF 50. The sensors 46 may also couple to the bottom wall 14 or may be positioned in or on a base layer 54. The base layer 54 may be a friction reducing layer or plate placed in the tank 10 to reduce friction on the magnetic stirrer 34 as it spins in the tank 10. Sensors may also be placed on the heating element 26 (e.g., proximate the magnetic stirrer 34).

In some embodiments, the controller 40 may control the electric coil 38 and thus the magnetic stirrer 34 in response to the detected amount of liquid DEF 48. For example, when the heating system 23 is first activated there may be little liquid DEF. The controller 40 may detect this through feedback from the sensors 46. In response, the controller 40 may not spin the magnetic stirrer 34 or may spin the magnetic stirrer 34 slowly. As more liquid DEF 48 is detected through feedback from sensors 46 (e.g., more sensors 46 may detect the presence of liquid DEF 48), the controller 40 may increase the spin rate of the magnetic stirrer 34 to increase agitation of the DEF 20. In other words, the controller 40 may increase the spin rate to increase agitation of the DEF 20 in order to increase convective heat transfer by moving heated liquid DEF 48 away from the heating element 26 and into contact with frozen DEF 50 that is progressively further away from the heating element 26. Increased agitation may also increase mixing and uniformity of the DEF 20.

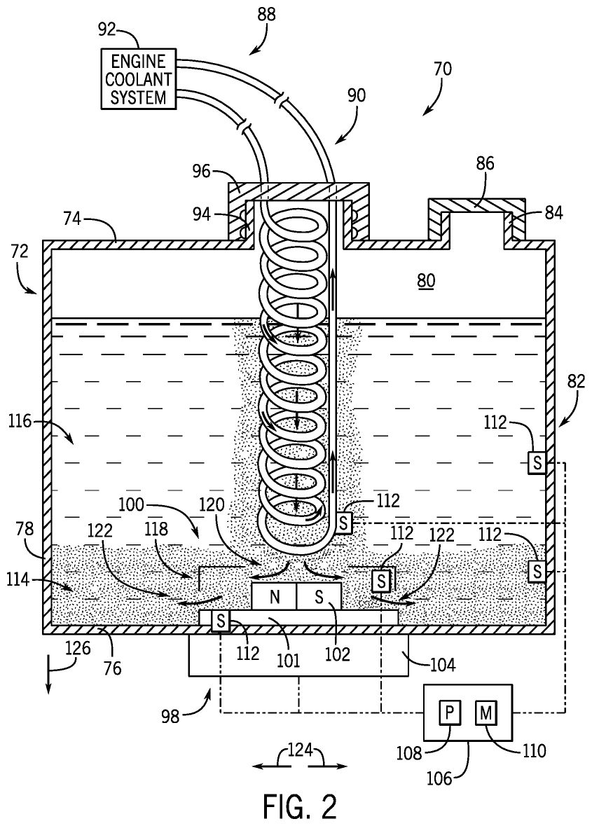

FIG. 2 is a cross-sectional view of a fluid tank thaw system 70 that couples to a tank 72. The tank 72 may be placed on an agricultural vehicle or otherwise used with an internal combustion engine (e.g., diesel engine). The tank 72 includes a top wall 74, a bottom wall 76, and a side wall 78 that extends vertically between the bottom wall 76 and the top wall 74. The side wall 78 may form a variety of shapes including square, rectangular, circular, oval, among others. Together the top wall 74, bottom wall 76, and side wall 78 form a cavity 80 that receives a diesel emission fluid 82 (DEF). The DEF 82 may enter the tank 72 through a first inlet 84 that is opened and closed with a cap 86.

As mentioned above, the DEF 82 may be a mixture of urea and water. This mixture may freeze during cold days blocking the release and use of the DEF 82 for use in reducing undesirable emissions. To enable the rapid melting of the DEF 82, the fluid tank thaw system 70 includes a heating system 88. The heating system 88 includes a heating element 90 that extends into the tank 72 to heat and melt the DEF 82. In one example, the heating element 90 may be a conduit that carries a fluid with a temperature that is greater than the freezing point of the DEF 82. For example, the heating element 90 may couple to the engine coolant system 92 enabling hot engine coolant to flow into and out of the tank 72. As illustrated, the heating element 90 is inserted into the cavity 80 through a second inlet 94 and held in place with a cap 96. The heating element 90 passes through the cap 96 enabling the cap 96 to couple to the heating element 90, which supports and facilitates its removal.

The fluid tank thaw system 70 includes a magnetic stir system 98. The magnetic stir system 98 includes a magnetic stirrer 100 that is placed within the tank 72. In some embodiments, the magnetic stirrer 100 may be placed on a friction reducing layer or plate 101. The magnetic stirrer 100 includes one or more permanent magnets 102. The permanent magnets 102 of the magnetic stirrer 100 are configured to interact with a magnetic field generated by an electric coil(s) 104. In operation, the electric coil 104 generates a magnetic field that attracts and/or repels the permanent magnet 102 of the magnetic stirrer 100. The rapid switching of the magnetic field between attracting and repelling poles of the permanent magnet 36 enables the electric coil 104 to drive rotation of the magnetic stirrer 100. As illustrated, the electric coil 104 is coupled to a bottom wall 76 of the tank 72. In some embodiments, the electric coil 104 may be placed within the tank 72 or within the wall bottom wall 76.

A controller 106 controls the generation of the magnetic field by the electric coil 104. The controller 106 includes a processor 108 and a memory 110. In operation, the processor 108 executes instructions stored by the memory 110 to control the electric coil 104. For example, the controller 106 may increase and decrease a spin rate of the magnetic stirrer 100 by controlling how often the polarity of the magnetic field generated by the electric coil 104 changes. In some embodiments, the fluid tank thaw system 70 may include one or more temperature sensors and/or liquid sensors 112. The controller 106 couples (e.g., wired and/or wirelessly) to these sensors 112 and in response to feedback may control operation of the electric coil 104. For example, the sensor 112 may be a temperature sensor that emits a signal indicative of the temperature of the surrounding DEF or a liquid sensor that detects the presence of a liquid (e.g., water). As the controller 106 receives this signal, the controller 106 determines if the surrounding DEF 82 is indicative of liquid DEF 114 or of frozen DEF 116. If indicative of liquid DEF 114, the controller 106 may determine that the magnetic stirrer 100 is not encased in frozen DEF 116 and is therefore able to facilitate convective heat transfer by agitating the DEF 82. Convective heat transfer via agitation of the DEF 82 may accelerate the melting of frozen DEF 50. The sensors 112 may be placed in a variety of locations in the tank 72 in order to detect the presence or absence of frozen DEF 116.

In some embodiments, the controller 106 may control the electric coil 104 and thus the magnetic stirrer 100 in response to the detected amount of liquid DEF 48. The controller 106 may detect this through feedback from the sensors 112. In response, the controller 106 may not spin the magnetic stirrer 100, spin the magnetic stirrer 100 slowly, or spin the magnetic stirrer 100 rapidly.

The magnetic stir system 98 includes a baffle 118 that extends over the magnetic stirrer 100. The baffle 118 defines an aperture 120 (e.g., axial aperture). In one example, the aperture 120 may be aligned with the heating element 90 (e.g., with a central axis of a coiled heating element 90). In operation, the baffle 118 enables the magnetic stirrer 100 to operate like a pump. For example, as the magnetic stirrer 100 spins, the magnetic stirrer 100 drives liquid DEF 114 radially outward through radial apertures 122 in the baffle 118. As the fluid accelerates and travels radially outward in direction 124 through the radial apertures 122, more liquid DEF 114 is drawn through the aperture 120 in direction 126. In other words, liquid DEF 114 inside and surrounding the coil of the heating element 90 moves in axial direction 126. In this way, the baffle 118 may facilitate circulation of liquid DEF 114 and facilitate convective heat transfer as well as mixing of the DEF 82 in the tank 72.

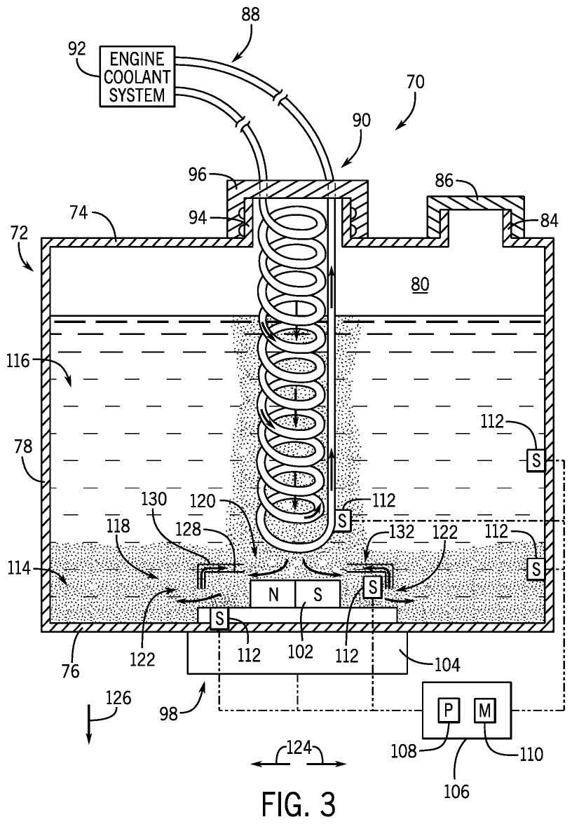

FIG. 3 is a cross-sectional view of the fluid tank thaw system 70 seen in FIG. 2. However, in FIG. 3 the baffle 118 includes an inner layer or baffle 128 and an outer layer or baffle 130. The inner baffle 128 and the outer baffle 130 are spaced apart to form a gap 132. As explained above, the baffle 118 defines an aperture 120 and radial apertures 122. In operation, the baffle 118 enables the magnetic stirrer 100 to operate like a pump. For example, as the magnetic stirrer 100 spins, the magnetic stirrer 100 drives liquid DEF 114 radially outward through radial apertures 122 in the baffle 118. As the fluid accelerates and travels radially outward in direction 124 through the radial apertures 122, more liquid DEF 114 is drawn through the aperture 120 in direction 126. In other words, liquid DEF 114 inside and surrounding the coil of the heating element 90 is drawn in axial direction 126. By including the inner baffle 128 and the outer baffle 130, the baffle 118 may increase agitation by recirculating a portion of the DEF 82 through the gap 132, which mixes with additional DEF 82 flowing in direction 126 through the aperture 120.

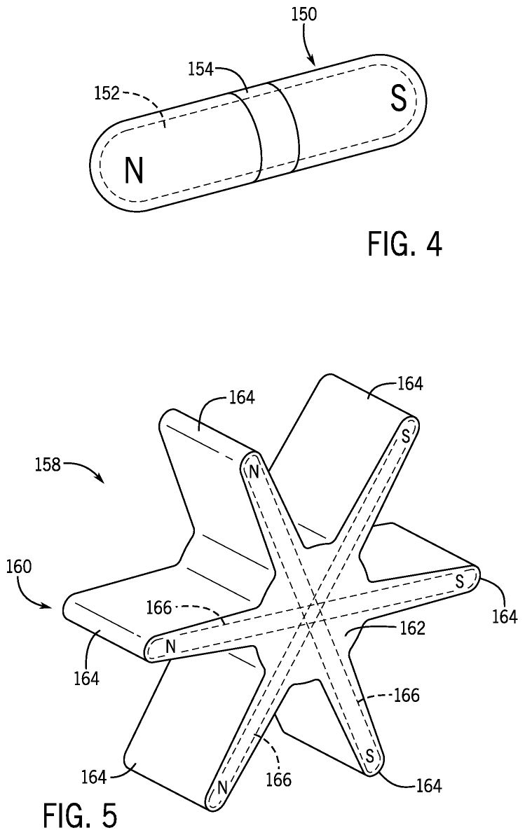

FIG. 4 is a perspective view of a magnetic stirrer 150. The magnetic stirrer 150 includes a magnet 152 encased in a shell or body 154 (e.g., bar). While a single magnet 152 is illustrated, it should be understood that the magnetic stirrer 150 may include additional magnets (e.g., 1, 2, 3, 4). The shell 154 may include an unreactive material (e.g., plastic). The shell 154 may also be durable and resist wear as the shell 154 spins in response to movement of the magnet 152. As illustrated, the shell 154 forms a cylindrical or pill-like shape that receives the magnet 152. In some embodiments, the shell 154 may be formed from two pieces that can be removable coupled together.

FIG. 5 is a perspective view of a magnetic stirrer 158. The magnetic stirrer 158 comprises a body 160 (e.g., impeller body) with a central portion 162 and a plurality of fins 164 that couple to the central portion 162. The body 160 houses one or more magnets 166 (e.g., 1, 2, 3, 4 or more). For example, each fin pair may include a magnet 166. In operation, the magnets 166 interact with a magnetic field produced by an electric coil. The interaction drives rotation of the magnetic stirrer 158 about a central axis of the central portion 162. As the magnetic stirrer 158 rotates, the fins 164 contact and agitates DEF in a tank. The body 160 may include an unreactive material (e.g., plastic). The body 160 may also be durable and resist wear as the body 160 spins in response to movement of the magnets 166. As illustrated, the body 160 forms a star-like shape with six fins 164. It should be understood the number of fins 164 may change (e.g., 1, 2, 3, 4, 5, 6, 7, 8, or more). The magnetic stirrer 158 may also be formed into different shapes.

Technical effects of the invention include melting and stirring of DEF with a magnetic stirrer. The magnetic stirrer may increase convective heat transfer and accelerate melting of frozen DEF. Operation of the magnetic stirrer may be controlled with a controller in response to a detected condition within the tank.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A fluid tank thaw system, comprising:
a fluid tank configured to receive a first fluid;
a heating element within the fluid tank and configured to heat the first fluid;
a magnetic stir system configured to stir the first fluid within the fluid tank to increase a thaw rate of the first fluid, the magnetic stir system, comprises:
a magnetic stirrer within the fluid tank, wherein the magnetic stirrer is configured to rotate within the fluid tank to agitate the first fluid; and
an electric coil configured to change polarity to rotate the magnetic stirrer.

2. The system of claim 1, wherein the heating element comprises an electric resistance heating element.

3. The system of claim 1, wherein the heating element comprises a conduit configured to receive a second fluid wherein the first fluid and the second fluid are different fluids.

4. The system of claim 3, wherein the second fluid is engine coolant.

5. The system of claim 1, wherein the heating element is a coil defining a central axis.

6. The system of claim 5, wherein the magnetic stirrer is aligned with the central axis of the coil.

7. The system of claim 1, comprising a friction plate within the fluid tank, wherein the friction plate is configured to support the magnetic stirrer.

8. The system of claim 1, wherein the electric coil is within the fluid tank.

9. The system of claim 1, comprising a baffle, wherein the baffle is between the heating element and the magnetic stirrer.

10. The system of claim 9, wherein the baffle defines an axial aperture, wherein the axial aperture aligns with a central axis of the heating element.

11. The system of claim 1, wherein the magnetic stirrer comprises an impeller body with a permanent magnet coupled to the impeller body.

12. The system of claim 1, wherein the magnetic stirrer comprises a bar with a permanent magnet coupled to the bar.

13. The system of claim 1, comprising a controller, wherein the controller is configured to control the electric coil to control a rotational speed of the magnetic stirrer.

14. The system of claim 13, comprising a liquid sensor, wherein the controller is configured to couple to the liquid sensor and to control the rotational speed of the magnetic stirrer in response to feedback from the liquid sensor.

15. A fluid tank thaw system, comprising:
a fluid tank configured to receive a first fluid;
a conduit within the fluid tank, the conduit is configured to guide a second fluid through the fluid tank to heat the first fluid;
a magnetic stir system configured to stir the first fluid within the fluid tank to increase a thaw rate of the first fluid, the magnetic stir system, comprises:
a magnetic stirrer within the fluid tank, wherein the magnetic stirrer is configured to rotate within the fluid tank to agitate the first fluid; and
an electric coil configured to change polarity to rotate the magnetic stirrer.

16. The system of claim 15, comprising a baffle, wherein the baffle is between a heating element and the magnetic stirrer.

17. The system of claim 16, wherein the baffle defines an axial aperture, wherein the axial aperture aligns with a central axis of the conduit.

18. The system of claim 15, wherein the magnetic stirrer comprises an impeller body with a permanent magnet coupled to the impeller body.

19. The system of claim 15, wherein the magnetic stirrer comprises a bar with a permanent magnet coupled to the bar.

20. The system of claim 15, comprising a controller, wherein the controller is configured to control the electric coil to control a rotational speed of the magnetic stirrer.
